(19) United States
(12) Patent Application Publication
(10) Pub. No.: US 2025/0105978 A1
(43) Pub. Date: Mar. 27, 2025

(54) DEVICES, METHODS AND COMPUTER READABLE MEDIA FOR FACILITATING THE LIMITED LCID SPACE

(71) Applicant: Nokia Technologies Oy, Espoo (FI)

(72) Inventors: Samuli Heikki TURTINEN, Ii (FI); Chunli WU, Beijing (CN); Benoist Pierre SEBIRE, Tokyo (JP)

(73) Assignee: Nokia Technologies Oy, Espoo (FI)

(21) Appl. No.: 18/725,304

(22) PCT Filed: Jan. 5, 2022
(86) PCT No.: PCT/CN2022/070205

§ 371 Date: Jun. 28, 2024

(51) Int. Cl. H04L 5/00; H04W 72/231; H04W 76/11

(52) U.S. Cl. CPC H04L 5/0053; H04W 72/231; H04W 76/11

(57) ABSTRACT

Disclosed are devices, methods, and computer programs for facilitating the limited logical channel identification (LCID) space. A terminal device in a communication network may comprise at least one processor and at least one memory having computer program code stored thereon and configured, with the at least one processor, cause the terminal device to perform: receiving, from a network device, a mapping configuration of at least one Logical Channel Identification (LCID) value and/or at least one extended LCID (eLCID) value configured by the network device for at least one Media Access Control (MAC) Control Element (CE), wherein the mapping configuration specifies an association between the at least one MAC CE is associated with the at least one Logical Channel Identification (LCID) value and/or the at least one extended LCID (eLCID) value.

### TECHNICAL FIELD

Various example embodiments described herein generally relate to communication technologies, and more particularly, to devices, methods, and computer readable media for facilitating the limited logical channel identification (LCID) space.

### BACKGROUND

In 5G New Radio, different kinds of data transfer services are offered by the media access control (MAC) layer. To accommodate different kinds of data transfer services, multiple types of logical channels are defined. A media access control (MAC) protocol data unit (PDU) may contain one or more MAC control elements (CEs) corresponding to one or more features requiring the MAC CEs. According to the third generation partnership project (3GPP) technical specification (TS) 38.321 V16.4.0, the MAC PDU contains a subheader with a logical channel identification (LCID) value or an extended LCID (eLCID) value. The LCID value or eLCID value may identify the logical channel instance or the type of corresponding MAC CE as described in the Tables 6.2.1-1, 6.2.1-1b, 6.2.1-2 and 6.2.1-2b in 3GPP TS 38.321 V16.4.0. As can be seen from the tables, there are currently very few LCID values available for new MAC CEs. The reserved values can be used to introduce new MAC CEs. However, as can be seen in the tables, only 12 LCID values for downlink-shared channel (DL-SCH) and 10 LCID values for uplink-shared channel (UL-SCH) are currently available. Although there are plenty of eLCID values available in both downlink (DL) and uplink (UL) directions, using an eLCID value will always result in one byte of additional overhead in the MAC subheader compared to a LCID value.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, an example embodiment of a terminal device in a communication network is provided. The terminal device may comprise at least one processor and at least one memory. At least one memory includes computer program code stored thereon. At least one memory and the computer program code may be configured to, with at least one processor, cause the terminal device to perform: receiving, from a network device, a mapping configuration of at least one Logical Channel Identification (LCID) value and/or at least one extended LCID (eLCID) value configured by the network device for at least one Media Access Control (MAC) Control Element (CE), wherein the mapping configuration specifies an association between the at least one MAC CE is associated with the at least one Logical Channel Identification (LCID) value and/or the at least one extended LCID (eLCID) value.

In some embodiments, the at least one MAC CE is associated with at least one pointer by which a respective one of the at least one MAC CE is linked to corresponding one or more of the at least one LCID value and/or the at least one eLCID value in radio resource control (RRC) signaling.

In some embodiments, the at least one pointer is an index with a value fixed in a radio standard specification or a value determined by the network device.

In some embodiments, receiving, from a network device, a mapping configuration of at least one Logical Channel Identification (LCID) value and/or the at least one extended LCID (eLCID) value configured by the network device for at least one Media Access Control (MAC) Control Element (CE) comprises: receiving, from the network device, the mapping configuration of the at least one Logical Channel Identification (LCID) value and/or the at least one extended LCID (eLCID) value for the at least one Media Access Control (MAC) Control Element (CE) through RRC signaling.

In some embodiments, receiving, from the network device, a mapping configuration of at least one Logical Channel Identification (LCID) value and/or the at least one extended LCID (eLCID) value configured by the network device for at least one Media Access Control (MAC) Control Element (CE) through RRC signaling comprises: receiving, from the network device, the mapping configuration of a set of LCID values and/or eLCID values for a set of MAC CEs through RRC signaling.

In some embodiments, the at least one MAC CE is associated with at least one LCID value including one or more reserved LCID values or one or more LCID values already allocated in a radio standard specification.

In some embodiments, the one or more LCID values already allocated in a radio standard specification include one or more LCID values for MAC CEs of features that the terminal device is unable to support and/or that the network device does not plan to use for the terminal device.

In some embodiments, the at least one MAC CE is associated with at least one reserved LCID value in the radio standard specification.

In some embodiments, the at least one MAC CE is associated with at least one of a reserved LCID value or an LCID value already allocated to identity of the logical channel in the radio standard specification which has not been assigned to any logical channel for the terminal device.

In some embodiments, the at least one MAC CE is associated with at least one default eLCID value in the radio standard specification and the at least one MAC CE is further associated with at least one available LCID value by the network device in a case where the at least one available LCID value is unused.

In some embodiments, the at least one MAC CE is associated with at least one default LCID value in the radio standard specification and the at least one MAC CE is further associated with at least one available eLCID value by the network device in a case where the at least one available eLCID value is unused.

In some embodiments, receiving, from a network device, a mapping configuration of at least one Logical Channel Identification (LCID) value and/or the at least one extended LCID (eLCID) value configured by the network device for at least one Media Access Control (MAC) Control Element (CE) comprises: receiving, from the network device, at least one priority to be used in logical channel prioritization for the at least one MAC CE.

In some embodiments, at least two MAC CEs are associated with a common LCID value, each of the at least two MAC CEs is also associated with a unique eLCID value respectively, and the common LCID value is used in a case where the at least two MAC CEs are sent in the same transport block (TB).

In some embodiments, the common LCID value is used for the MAC CE with the highest priority if configured.

In some embodiments, a fixed sequence of MAC CEs is associated with a LCID value and/or an eLCID value by the network device.

In some embodiments, tables of mapping of the at least one MAC CE to the at least one LCID value and/or the at least one eLCID value are specified in the radio standard specification, and the table to be used to associate the at least one MAC CE with the at least one LCID value and/or the at least one eLCID value is determined by the network device.

In a second aspect, an example embodiment of a network device in a communication network is provided. The network device may comprise at least one processor and at least one memory. At least one memory includes computer program code stored thereon. At least one memory and the computer program code may be configured to, with at least one processor, cause the network device to perform: associating at least one Media Access Control (MAC) Control Element (CE) with at least one Logical Channel Identification (LCID) value and/or at least one extended LCID (eLCID) value; and transmitting, to a terminal device, a mapping configuration of the at least one Logical Channel Identification (LCID) value and/or the at least one extended LCID (eLCID) value for the at least one MAC CE, wherein the mapping configuration specifies an association between the at least one MAC CE and the at least one Logical Channel Identification (LCID) value and/or the at least one extended LCID (eLCID) value.

In some embodiments, associating at least one MAC CE with at least one LCID value and/or at least one eLCID value comprises: associating the at least one MAC CE with at least one pointer by which a respective one of the at least one MAC CE is linked to corresponding one or more of the at least one LCID value and/or the at least one eLCID value in radio resource control (RRC) signaling.

In some embodiments, the at least one pointer is an index with a value fixed in a radio standard specification or a value determined by the network device.

In some embodiments, transmitting, to a terminal device, a mapping configuration of the at least one Logical Channel Identification (LCID) value and/or the at least one extended LCID (eLCID) value for the at least one MAC CE comprises: transmitting, to the terminal device, the mapping configuration of the at least one Logical Channel Identification (LCID) value and/or the at least one extended LCID (eLCID) value for the at least one MAC CE through RRC signaling.

In some embodiments, transmitting, to the terminal device, a mapping configuration of the at least one Logical Channel Identification (LCID) value and/or the at least one extended LCID (eLCID) value for the at least one MAC CE through RRC signaling comprises: transmitting, to the terminal device, the mapping configuration of a set of LCID values and/or eLCID values for a set of MAC CEs through RRC signaling.

In some embodiments, associating at least one MAC CE with at least one LCID value and/or at least one eLCID value comprises: associating the at least one MAC CE with at least one LCID value including one or more reserved LCID values or one or more LCID values already allocated in a radio standard specification.

In some embodiments, the one or more LCID values already allocated in a radio standard specification include one or more LCID values for MAC CEs of features that the terminal device is unable to support and/or that the network device does not plan to use for the terminal device.

In some embodiments, associating at least one MAC CE with at least one LCID value and/or at least one eLCID value comprises: associating the at least one MAC CE with at least one reserved LCID value in the radio standard specification.

In some embodiments, associating at least one MAC CE with at least one LCID value and/or at least one eLCID value comprises: associating the at least one MAC CE with at least one of a reserved LCID value or an LCID value already allocated to identity of the logical channel in the radio standard specification which has not been assigned to any logical channel for the terminal device.

In some embodiments, the at least one MAC CE is associated with at least one default eLCID value in the radio standard specification, and associating at least one MAC CE with at least one LCID value and/or at least one eLCID value comprises: associating the at least one MAC CE with at least one available LCID value in a case where the at least one available LCID value is unused.

In some embodiments, the at least one MAC CE is associated with at least one default LCID value in the radio standard specification, and associating at least one MAC CE with at least one LCID value and/or at least one eLCID value comprises: associating the at least one MAC CE with at least one available eLCID value in a case where the at least one available eLCID value is unused.

In some embodiments, transmitting, to a terminal device, a mapping configuration of the at least one Logical Channel Identification (LCID) value and/or the at least one extended LCID (eLCID) value for the at least one MAC CE comprises: transmitting, to the terminal device, at least one priority to be used in logical channel prioritization for the at least one MAC CE.

In some embodiments, associating at least one MAC CE with at least one LCID value and/or at least one eLCID value comprises: associating at least two MAC CEs with a common LCID value; and associating each of the at least two MAC CEs with a unique eLCID value respectively, wherein the common LCID value is used in a case where the at least two MAC CEs are transmitted in the same transport block (TB).

In some embodiments, the common LCID value is used for the MAC CE with the highest priority if configured.

In some embodiments, associating at least one MAC CE with at least one LCID value and/or at least one eLCID value comprises: associating a fixed sequence of MAC CEs with a LCID value and/or an eLCID value.

In some embodiments, tables of mapping of the at least one MAC CE to the at least one LCID value and/or the at least one eLCID value are specified in the radio standard specification, and associating at least one MAC CE with at least one LCID value and/or at least one eLCID value comprises: determining the table to be used to associate the at least one MAC CE with the at least one LCID value and/or the at least one eLCID value.

In a third aspect, an example embodiment of a method implemented at a terminal device in a communication network is provided. The method may comprise: receiving, from a network device, a mapping configuration of at least one Logical Channel Identification (LCID) value and/or at least one extended LCID (eLCID) value configured by the network device for at least one Media Access Control (MAC) Control Element (CE), wherein the mapping configuration specifies an association between the at least one MAC CE is associated with the at least one Logical Channel Identification (LCID) value and/or the at least one extended LCID (eLCID) value.

In some embodiments, the at least one MAC CE is associated with at least one pointer by which a respective one of the at least one MAC CE is linked to corresponding one or more of the at least one LCID value and/or the at least one eLCID value in radio resource control (RRC) signaling.

In some embodiments, the at least one pointer is an index with a value fixed in a radio standard specification or a value determined by the network device.

In some embodiments, receiving, from a network device, a mapping configuration of at least one Logical Channel Identification (LCID) value and/or the at least one extended LCID (eLCID) value configured by the network device for at least one Media Access Control (MAC) Control Element (CE) comprises: receiving, from the network device, the mapping configuration of the at least one Logical Channel Identification (LCID) value and/or the at least one extended LCID (eLCID) value for the at least one Media Access Control (MAC) Control Element (CE) through RRC signaling.

In some embodiments, receiving, from the network device, a mapping configuration of at least one Logical Channel Identification (LCID) value and/or the at least one extended LCID (eLCID) value configured by the network device for at least one Media Access Control (MAC) Control Element (CE) through RRC signaling comprises: receiving, from the network device, the mapping configuration of a set of LCID values and/or eLCID values for a set of MAC CEs through RRC signaling.

In some embodiments, the at least one MAC CE is associated with at least one LCID value including one or more reserved LCID values or one or more LCID values already allocated in a radio standard specification.

In some embodiments, the one or more LCID values already allocated in a radio standard specification include one or more LCID values for MAC CEs of features that the terminal device is unable to support and/or that the network device does not plan to use for the terminal device.

In some embodiments, the at least one MAC CE is associated with at least one reserved LCID value in the radio standard specification.

In some embodiments, the at least one MAC CE is associated with at least one of a reserved LCID value or an LCID value already allocated to identity of the logical channel in the radio standard specification which has not been assigned to any logical channel for the terminal device.

In some embodiments, the at least one MAC CE is associated with at least one default eLCID value in the radio standard specification and the at least one MAC CE is further associated with at least one available LCID value by the network device in a case where the at least one available LCID value is unused.

In some embodiments, the at least one MAC CE is associated with at least one default LCID value in the radio standard specification and the at least one MAC CE is further associated with at least one available eLCID value by the network device in a case where the at least one available eLCID value is unused.

In some embodiments, receiving, from a network device, a mapping configuration of at least one Logical Channel Identification (LCID) value and/or the at least one extended LCID (eLCID) value configured by the network device for at least one Media Access Control (MAC) Control Element (CE) comprises: receiving, from the network device, at least one priority to be used in logical channel prioritization for the at least one MAC CE.

In some embodiments, at least two MAC CEs are associated with a common LCID value, each of the at least two MAC CEs is also associated with a unique eLCID value respectively, and the common LCID value is used in a case where the at least two MAC CEs are sent in the same transport block (TB).

In some embodiments, the common LCID value is used for the MAC CE with the highest priority if configured.

In some embodiments, a fixed sequence of MAC CEs is associated with a LCID value and/or an eLCID value by the network device.

In some embodiments, tables of mapping of the at least one MAC CE to the at least one LCID value and/or the at least one eLCID value are specified in the radio standard specification, and the table to be used to associate the at least one MAC CE with the at least one LCID value and/or the at least one eLCID value is determined by the network device.

In a fourth aspect, an example embodiment of a method implemented at a network device in a communication network is provided. The method may comprise associating at least one Media Access Control (MAC) Control Element (CE) with at least one Logical Channel Identification (LCID) value and/or at least one extended LCID (eLCID) value; and transmitting, to a terminal device, a mapping configuration of the at least one Logical Channel Identification (LCID) value and/or the at least one extended LCID (eLCID) value for the at least one MAC CE, wherein the mapping configuration specifies an association between the at least one MAC CE and the at least one Logical Channel Identification (LCID) value and/or the at least one extended LCID (eLCID) value.

In some embodiments, associating at least one MAC CE with at least one LCID value and/or at least one eLCID value comprises: associating the at least one MAC CE with at least one pointer by which a respective one of the at least one MAC CE is linked to corresponding one or more of the at least one LCID value and/or the at least one eLCID value in radio resource control (RRC) signaling.

In some embodiments, the at least one pointer is an index with a value fixed in a radio standard specification or a value determined by the network device.

In some embodiments, transmitting, to a terminal device, a mapping configuration of the at least one Logical Channel Identification (LCID) value and/or the at least one extended LCID (eLCID) value for the at least one MAC CE comprises: transmitting, to the terminal device, the mapping configuration of the at least one Logical Channel Identification (LCID) value and/or the at least one extended LCID (eLCID) value for the at least one MAC CE through RRC signaling.

In some embodiments, transmitting, to the terminal device, a mapping configuration of the at least one Logical Channel Identification (LCID) value and/or the at least one extended LCID (eLCID) value for the at least one MAC CE through RRC signaling comprises: transmitting, to the terminal device, the mapping configuration of a set of LCID values and/or eLCID values for a set of MAC CEs through RRC signaling.

In some embodiments, associating at least one MAC CE with at least one LCID value and/or at least one eLCID value comprises: associating the at least one MAC CE with at least one LCID value including one or more reserved LCID values or one or more LCID values already allocated in a radio standard specification.

In some embodiments, the one or more LCID values already allocated in a radio standard specification include one or more LCID values for MAC CEs of features that the terminal device is unable to support and/or that the network device does not plan to use for the terminal device.

In some embodiments, associating at least one MAC CE with at least one LCID value and/or at least one eLCID value comprises: associating the at least one MAC CE with at least one reserved LCID value in the radio standard specification.

In some embodiments, associating at least one MAC CE with at least one LCID value and/or at least one eLCID value comprises: associating the at least one MAC CE with at least one of a reserved LCID value or an LCID value already allocated to identity of the logical channel in the radio standard specification which has not been assigned to any logical channel for the terminal device.

In some embodiments, the at least one MAC CE is associated with at least one default eLCID value in the radio standard specification, and associating at least one MAC CE with at least one LCID value and/or at least one eLCID value comprises: associating the at least one MAC CE with at least one available LCID value in a case where the at least one available LCID value is unused.

In some embodiments, the at least one MAC CE is associated with at least one default LCID value in the radio standard specification, and associating at least one MAC CE with at least one LCID value and/or at least one eLCID value comprises: associating the at least one MAC CE with at least one available eLCID value in a case where the at least one available eLCID value is unused.

In some embodiments, transmitting, to a terminal device, a mapping configuration of the at least one Logical Channel Identification (LCID) value and/or the at least one extended LCID (eLCID) value for the at least one MAC CE comprises: transmitting, to the terminal device, at least one priority to be used in logical channel prioritization for the at least one MAC CE.

In some embodiments, associating at least one MAC CE with at least one LCID value and/or at least one eLCID value comprises: associating at least two MAC CEs with a common LCID value; and associating each of the at least two MAC CEs with a unique eLCID value respectively, wherein the common LCID value is used in a case where the at least two MAC CEs are transmitted in the same transport block (TB).

In some embodiments, the common LCID value is used for the MAC CE with the highest priority if configured.

In some embodiments, associating at least one MAC CE with at least one LCID value and/or at least one eLCID value comprises: associating a fixed sequence of MAC CEs with a LCID value and/or an eLCID value.

In some embodiments, tables of mapping of the at least one MAC CE to the at least one LCID value and/or the at least one eLCID value are specified in the radio standard specification, and associating at least one MAC CE with at least one LCID value and/or at least one eLCID value comprises: determining the table to be used to associate the at least one MAC CE with the at least one LCID value and/or the at least one eLCID value.

In a fifth aspect, an example embodiment of an apparatus in a communication network is provided. Apparatus may comprise means for receiving, from a network device, a mapping configuration of at least one Logical Channel Identification (LCID) value and/or at least one extended LCID (eLCID) value configured by the network device for at least one Media Access Control (MAC) Control Element (CE), wherein the mapping configuration specifies an association between the at least one MAC CE is associated with the at least one Logical Channel Identification (LCID) value and/or the at least one extended LCID (eLCID) value.

In a sixth aspect, an example embodiment of an apparatus in a communication network is provided. Apparatus may comprise means for associating at least one Media Access Control (MAC) Control Element (CE) with at least one Logical Channel Identification (LCID) value and/or at least one extended LCID (eLCID) value; and means for transmitting, to a terminal device, a mapping configuration of the at least one Logical Channel Identification (LCID) value and/or the at least one extended LCID (eLCID) value for the at least one MAC CE, wherein the mapping configuration specifies an association between the at least one MAC CE and the at least one Logical Channel Identification (LCID) value and/or the at least one extended LCID (eLCID) value.

In a seventh aspect, an example embodiment of a computer program is provided. The computer program may comprise instructions stored on a computer readable medium. The instructions may, when executed by at least one processor of a terminal device in a communication network, cause the terminal device to perform: receiving, from a network device, a mapping configuration of at least one Logical Channel Identification (LCID) value and/or at least one extended LCID (eLCID) value configured by the network device for at least one Media Access Control (MAC) Control Element (CE), wherein the mapping configuration specifies an association between the at least one MAC CE is associated with the at least one Logical Channel Identification (LCID) value and/or the at least one extended LCID (eLCID) value.

In an eighth aspect, an example embodiment of a computer program is provided. The computer program may comprise instructions stored on a computer readable medium. The instructions may, when executed by at least one processor of a network device in a communication network, cause the network device to perform: associating at least one Media Access Control (MAC) Control Element (CE) with at least one Logical Channel Identification (LCID) value and/or at least one extended LCID (eLCID) value; and transmitting, to a terminal device, a mapping configuration of the at least one Logical Channel Identification (LCID) value and/or the at least one extended LCID (eLCID) value for the at least one MAC CE, wherein the mapping configuration specifies an association between the at least one MAC CE and the at least one Logical Channel Identification (LCID) value and/or the at least one extended LCID (eLCID) value.

Other features and advantages of the example embodiments of the present disclosure will also be apparent from the following description of specific embodiments when read in conjunction with accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to accompanying drawings.

FIG. 1 is a schematic diagram illustrating a communication system 100 in which example embodiments of the present application may be implemented.

FIG. 2 shows an exemplary sequence diagram for facilitating the limited logical channel identification (LCID) space according to an embodiment of the present disclosure.

FIG. 3 shows a block diagram illustrating an example communication network 300 for facilitating the limited logical channel identification (LCID) space in which example embodiments of the present disclosure can be implemented.

FIG. 4 shows a flow chart illustrating an example method 400 for facilitating the limited logical channel identification (LCID) space according to an embodiment of the present disclosure.

FIG. 5 shows a flow chart illustrating an example method 500 for facilitating the limited logical channel identification (LCID) space according to an embodiment of the present disclosure.

FIG. 6 shows a block diagram illustrating an example apparatus 600 for facilitating the limited logical channel identification (LCID) space according to an embodiment of the present disclosure.

FIG. 7 shows a block diagram illustrating an example apparatus 700 for facilitating the limited logical channel identification (LCID) space according to an embodiment of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to accompanying drawings. The following description includes specific details for the purpose of providing a thorough understanding of various concepts. However, it will be apparent to those skilled in art that these concepts may be practiced without these specific details. In some instances, well known circuits, techniques and components are shown in block diagram form to avoid obscuring the described concepts and features.

As used herein, the term “network device” refers to any suitable entities or devices that can provide cells or coverage, through which the terminal device can access the network or receive services. The network device may be commonly referred to as a base station. The term “base station” used herein can represent a node B (NodeB or NB), an evolved node B (eNodeB or eNB), or a gNB or an ng-eNB. The base station may be embodied as a macro base station, a relay node, an Integrated Access and Backhaul (IAB) node, or a low power node such as a pico base station or a femto base station. The base station may consist of several distributed network units, such as a central unit (CU), one or more distributed units (DUs), one or more remote radio heads (RRHs) or remote radio units (RRUs). The number and functions of these distributed units depend on the selected split RAN architecture.

As used herein, the term “terminal device” or “user equipment” (UE) refers to any entities or devices that can wirelessly communicate with the network devices or with each other. Examples of the terminal device can include a mobile phone, a mobile terminal, a mobile station, a subscriber station, a portable subscriber station, an access terminal, a computer, a wearable device, an on-vehicle communication device, a machine type communication (MTC) device, an internet of things (IoT) device, an internet of everything (IoE) device, a device-to-device (D2D) communication device, a vehicle to everything (V2X) communication device, a sensor and the like. The term “terminal device” can be used interchangeably with UE, a user terminal, a mobile terminal, a mobile station, or a wireless device.

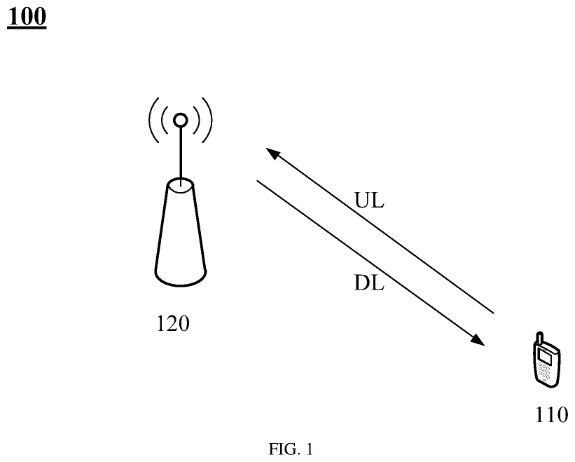

FIG. 1 illustrates a schematic diagram of a communication system 100 in which example embodiments of the present disclosure may be implemented. Referring to FIG. 1, the communication system 100 may include a user equipment (UE) 110 and a network device 120. The UE 110 may communicate with the network device 120 on uplink (UL) and downlink (DL) channels. The UE 110 and the network device 120 may be a part of a cellular communication network, such as a 5G NR network, in which the UE 110 may be implemented as an NR-enabled UE 110, and the network device 120 may be implemented as a next Generation Node-B (gNB). It would be appreciated that the NR network may comprise more than one UE 110 and/or more than one network devices 120. The UE 110 may wirelessly communicate with the network device 120 on uplink (UL) and downlink (DL) channels. Although not shown, the network device 120 may also connect to other base stations via wireless or wired connections. The network device 120 may provide access to the network for the UE 110.

The number of reserved LCID values available for new MAC CEs is much lower than the number of MAC CEs that need to be introduced. Using eLCID instead is an obvious solution but since it increases overhead, it will impact uplink coverage or make the possible multiplexing into reduced payload messages, such as random access (RA) Msg3/Msg A, very challenging, if not impossible. Selecting which new MAC CE should benefit from the LCID space, as opposed to relying on the eLCID space, is a difficult decision. On the other hand, the usage of many of the MAC CEs defined are behind an explicit configuration for a feature in the RRC connected state, which means that many of the LCID values may be unnecessarily reserved for a given UE 110 not supporting or not using at the moment a certain feature, e.g. the LCID values for MAC CEs of listen before talk (LBT) and sidelink buffer status report (BSR) may not be used for the UEs 110 not supporting unlicensed band and/or sidelink. Besides, since typically most network (NW) implementation does not support or configure that many data radio bearers (DRBs) or logical channels (LCHs) for a UE 110, those LCID values reserved for identity of the logical channels may be also unused most of the time as well.

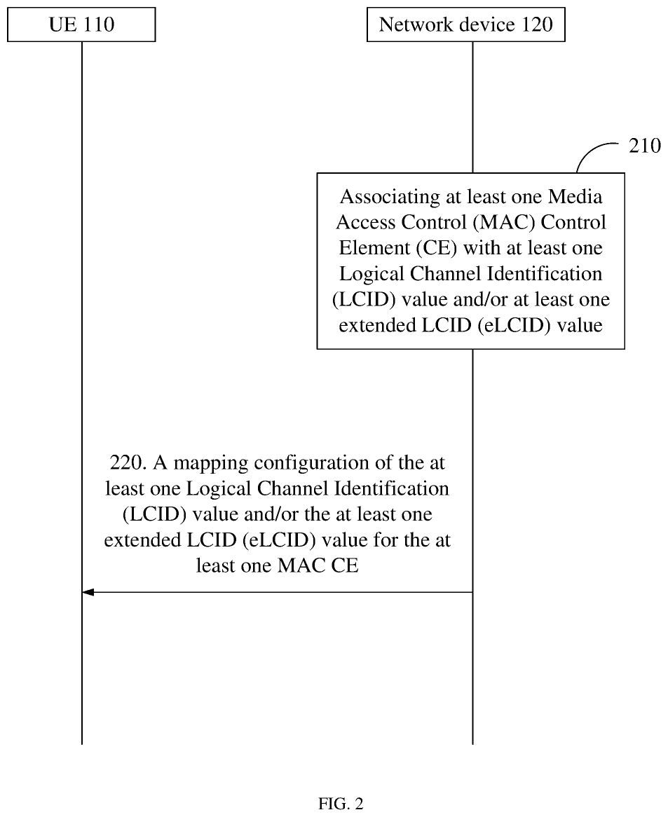

FIG. 2 shows an exemplary sequence diagram for facilitating the limited logical channel identification (LCID) space according to an embodiment of the present disclosure. In an operation 210, the network device 120 may associate at least one Media Access Control (MAC) Control Element (CE) with at least one Logical Channel Identification (LCID) value and/or at least one extended LCID (eLCID) value.

In one embodiment, the network device 120 may associate the at least one MAC CE with at least one pointer by which a respective one of the at least one MAC CE is linked to corresponding one or more of the at least one LCID value and/or the at least one eLCID value in radio resource control (RRC) signaling. In another embodiment, the at least one pointer may be an index with a value fixed in a radio standard specification or a value determined by the network device. In one embodiment, as used herein, the radio standard specification or the specification may be a 3GPP technical specification. For example, in an example embodiment, each MAC CE may be associated with a MAC CE pointer that is decoupled from the LCID value used in the MAC CE. That MAC CE pointer may be used to link a MAC CE to a given LCID value or eLCID value through RRC signaling. In Abstract Syntax Notation One (ASN.1), the MAC CE pointer can be an index with a value fixed in the technical specification, or the MAC CE pointer can also be an enumerated value determined by the network device 120.

In one embodiment, the network device 120 may associate the at least one MAC CE with at least one LCID value including one or more reserved LCID values or one or more LCID values already allocated in a radio standard specification. In one example embodiment, the network device 120 may associate any reserved LCID value or already allocated LCID in the radio standard specification (for example, allocated for a MAC CE or a logical channel in the specification). In another embodiment, the one or more LCID values already allocated in a radio standard specification include one or more LCID values for MAC CEs of features that the UE 110 is unable to support and/or that the network device 120 does not plan to use for the UE 110. For example, in one example embodiment, the network device 120 may associate any LCID value to a new MAC CE, including the ones for which a fixed LCID value is already allocated in the technical specification. That is, in this example embodiment, the association is not limited to the reserved LCID values in the Tables 6.2.1-1 and 6.2.1-2 of the technical specification TS 38.321. Other LCID values or eLCID values may also be associated with a new MAC CE by the network device 120. In another example embodiment, for example, the LCID values for MAC CEs of listen before talk (LBT) and sidelink buffer status report (BSR) may not be used for the UEs 110 not supporting unlicensed band and/or sidelink, and/or the network device 120 does not plan to use them for those UEs 110. In this case, the network device 120 may associate the at least one new MAC CE with at least one of those LCID values for MAC CEs of listen before talk (LBT) and sidelink buffer status report (BSR) to reutilize those LCID values.

In another embodiment, the network device 120 may associate the at least one MAC CE with at least one reserved LCID value in the radio standard specification. Specifically, in one example embodiment, the network device 120 may not override any LCID values already assigned to MAC CEs that do not require explicit configuration in the RRC connected state. For example, the LCID values for buffer status report (BSR) or power headroom report (PHR) may be already used before the RRC configuration or they are mandatory ones since 3GPP Release 15 (Rel-15), so they may not be assigned to new MAC CEs through RRC configuration. In other words, in this example embodiment, only the reserved LCID values may be associated with the new MAC CEs.

In another embodiment, the network device 120 may associate the at least one MAC CE with at least one of a reserved LCID value or an LCID value already allocated to identity of the logical channel in the radio standard specification (which may not be assigned to any logical channel for the UE 110). For example, in one example embodiment, assuming only the reserved LCID values may be associated with the new MAC CEs as described in the example embodiment above, an exception, however, may be made for the LCID values currently allocated to identity of the logical channel, since there are not many logical channels (LCHs) configured for the UE 110 and the network device 120 may be in control of the LCH configuration. In other words, in this example embodiment, the network device 120 may associate both the reserved LCID values and unused LCID values for LCHs with the new MAC CEs.

In one embodiment, the at least one MAC CE may be associated with at least one default eLCID value in the radio standard specification, and the network device 120 may further associate the at least one MAC CE with at least one available LCID value in a case where the at least one available LCID value is unused. For example, in one example embodiment, each of the new MAC CEs may be assigned a fixed eLCID value specified in the technical specification, and if no explicit LCID configuration is signaled by network device 120, that default eLCID value applies. By means of this, any new MAC CE may be allocated from eLCID space the fixed value while network device 120 may allocate them an LCID value to be used by a UE 110 based on explicit configuration when there are available LCID values.

In one embodiment, the at least one MAC CE may be associated with at least one default LCID value in the specification, and the network device 120 may further associate the at least one MAC CE with at least one available eLCID value in a case where the at least one available eLCID value is unused. For example, in one example embodiment, at least one of the new MAC CEs may be assigned a fixed LCID value specified in the technical specification, and if no explicit eLCID configuration is signaled by network device 120, that default LCID value applies. By means of this, network device 120 may allocate the LCID value associated with the at least one MAC CE to another MAC CE to be used by a UE 110 based on explicit configuration and allocate the at least one MAC CE with an eLCID value instead.

In one embodiment, at least two MAC CEs may be associated with a common LCID value, and each of the at least two MAC CEs may be also associated with a unique eLCID value respectively. Then, the common LCID value may be used in a case where the at least two MAC CEs are sent in the same transport block (TB). In one embodiment, the common LCID value is used for the MAC CE with the highest priority if configured. For example, in an example embodiment, both an LCID value and a unique eLCID value are associated with the same MAC CE, and several MAC CEs may use the same common LCID value. Then, in logical channel prioritization, only when all MAC CEs associated with the same common LCID value are included in the TB, can one of them, for instance, the one with highest priority if configured, use the common LCID value. More specifically, assuming a MAC CE A is associated with LCID value 1 and eLCID value 21, and a MAC CE B is associated with LCID value 1 and eLCID value 22, when MAC CE A is sent in a TB without MAC CE B, eLCID value 21 is used. But when both MAC CE A and B are included in the same TB, MAC CE A can use LCID value 1 and MAC CE B may use eLCID value 22. By receiving eLCID value 22, it may be possible to determine that the MAC CE corresponding to LCID value 1 may be then MAC CE A. This may reduce overhead.

In one embodiment, the network device 120 may associate a fixed sequence of MAC CEs with a LCID value and/or an eLCID value. This may reduce overhead even further

In another embodiment, tables of mapping of the at least one MAC CE to the at least one LCID value and/or the at least one eLCID value may be specified in the radio standard specification, and the network device 120 may determine the table to be used to associate the at least one MAC CE with the at least one LCID value and/or the at least one eLCID value. For example, several tables of MAC CE to LCID value mappings may be specified in the technical specification and the network device 120 may signal which table is to be used. Obviously, the MAC CEs which can be used before RRC connection establishment (i.e. before RRC Setup is received) need to be common amongst those tables. Alternatively, the table to be used during RRC connection establishment may be broadcast in system information.

Then, in an operation 220, the network device 120 may transmit, to a UE 110, configuration of the at least one Logical Channel Identification (LCID) value and/or the at least one extended LCID (eLCID) value for the at least one MAC CE associated with the at least one LCID value and/or the at least one eLCID value. On the other hand, the UE 110 may receive, from the network device 120, configuration of the at least one Logical Channel Identification (LCID) value and/or the at least one extended LCID (eLCID) value for the at least one Media Access Control (MAC) Control Element (CE). The at least one MAC CE may be associated with the at least one Logical Channel Identification (LCID) value and/or the at least one extended LCID (eLCID) value by the network device 120.

In one embodiment, the network device 120 may transmit, to the UE 110, the mapping configuration of the at least one Logical Channel Identification (LCID) value and/or the at least one extended LCID (eLCID) value for the at least one Media Access Control (MAC) Control Element (CE) through RRC signaling. On the other hand, the UE 110 may receive, from the network device 120, the mapping configuration of the at least one Logical Channel Identification (LCID) value and/or the at least one extended LCID (eLCID) value for the at least one MAC CE through RRC signaling. For example, the network device 120 may signal the LCID value or the eLCID value associated with a MAC CE in the configuration of the corresponding feature requiring that MAC CE in RRC signaling.

In another embodiment, the network device 120 may transmit, to UE 110, the mapping configuration of a set of LCID values and/or eLCID values device for a set of MAC CEs through RRC signaling. On the other hand, the UE 110 may receive, from the network device 120, the mapping configuration of a set of LCID values and/or eLCID values configured by the network device for a set of MAC CEs through RRC signaling. For example, the network device 120 may configure the whole set of new MAC CEs and their associated LCID values or eLCID values to be used by the UE 110 through RRC signaling.

In one embodiment, when the network device 120 transmits, to the UE 110, a mapping configuration of at least one Logical Channel Identification (LCID) value and/or the at least one extended LCID (eLCID) value for at least one Media Access Control (MAC) Control Element (CE), the network device 120 may also transmit, to the UE 110, at least one priority to be used in logical channel prioritization for the at least one MAC CE. On the other hand, when the UE 110 receives, from the network device 120, a mapping configuration of at least one Logical Channel Identification (LCID) value and/or the at least one extended LCID (eLCID) value configured by the network device for at least one Media Access Control (MAC) Control Element (CE), the UE 110 may also receive, from the network device 120, at least one priority to be used in logical channel prioritization for the at least one MAC CE. For example, the configuration of the LCID value may be accompanied by a priority to be used in logical channel prioritization for that MAC CE.

According to the present disclosure, the scarcely reserved LCID values may remain reserved and may be further used dynamically depending on the features the UE 110 supports. The LCID space may also be used for future MAC CEs that require lower overhead, especially for the uplink-shared channel (UL-SCH). Since those MAC CEs may be associated with a LCID value or an eLCID value used in the RRC connected state, there is no issue with using different values for different UEs 110 for the same MAC CE even if the network device 120 chooses to do so. There is thus no need for lengthy discussions on which MAC CE deserves a LCID value or which MAC CE deserves an eLCID value. The UEs 110 not implementing a certain feature do not have to suffer from the LCID space increase corresponding to that certain feature.

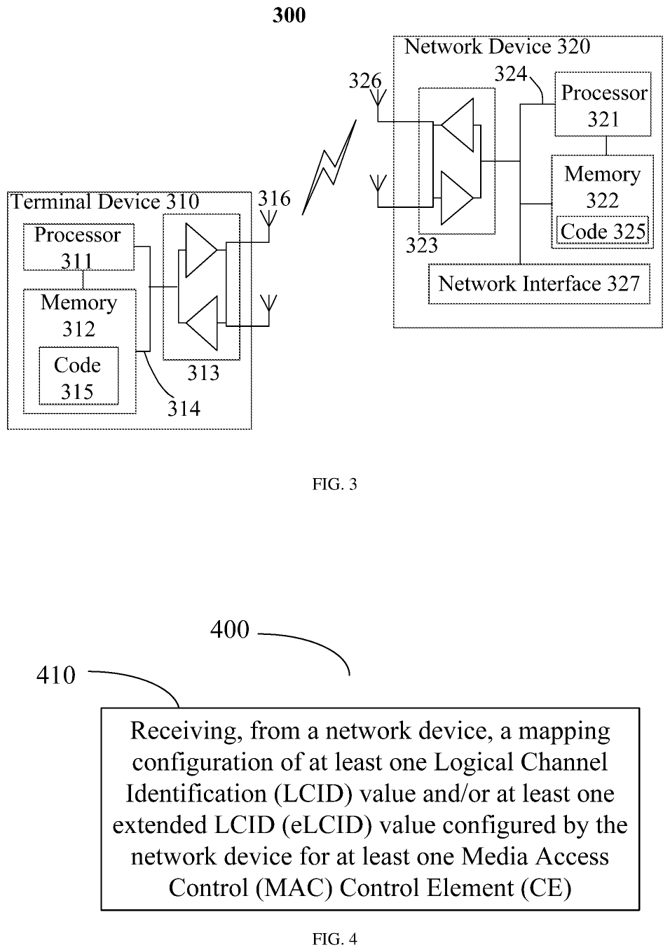

FIG. 3 is a block diagram illustrating a communication network 300 in which example embodiments of the present disclosure can be implemented. The communication network 300 may be a part of a larger communication network or system. As shown in FIG. 3, the communication network 300 may include a terminal device 310 which may be implemented as the UE 110 discussed above, and a network device 320 which may be implemented as a base station (gNB) or the network device 120 discussed above.

Referring to FIG. 3, the terminal device 310 may comprise one or more processors 311, one or more memories 312 and one or more transceivers 313 interconnected through one or more buses 314. The one or more buses 314 may be address, data, or control buses, and may include any interconnection mechanism such as series of lines on a motherboard or integrated circuit, copper cables, optical fibers, or other electrical/optical communication equipment, and the like. Each of the one or more transceivers 313 may comprise a receiver and a transmitter, which are connected to a plurality of antennas 316. The plurality of antennas 316 may form an antenna array to perform beamforming communication with the network device 320. The one or more memories 312 may include computer program code 315. The one or more memories 312 and the computer program code 315 may be configured to, when executed by the one or more processors 311, cause the terminal device 310 to perform operations and procedures relating to the UE 110 as described above.

The network device 320 may be implemented as a single network node, or disaggregated/distributed over two or more network nodes, such as a central unit (CU), a distributed unit (DU), a remote radio head-end (RRH), using different functional-split architectures and different interfaces. The network device 320 may comprise one or more processors 321, one or more memories 322, one or more transceivers 323 and one or more network interfaces 327 interconnected through one or more buses 324. The one or more buses 324 may be address, data, or control buses, and may include any interconnection mechanism such as a series of lines on a motherboard or integrated circuit, copper cables, optical fibers, or other electrical/optical communication equipment, and the like. Each of the one or more transceivers 323 may comprise a receiver and a transmitter, which are connected to a plurality of antennas 326. The network device 320 may operate as a base station for the terminal device 310 and wirelessly communicate with the terminal device 310 through the plurality of antennas 326. The plurality of antennas 326 may form an antenna array to perform beamforming communication with the terminal device 310. The one or more network interfaces 327 may provide wired or wireless communication links through which the network device 320 may communicate with other network devices, entities or functions. The one or more memories 322 may include computer program code 325. The one or more memories 322 and the computer program code 325 may be configured to, when executed by the one or more processors 321, cause the network device 320 to perform operations and procedures relating to the base station (gNB) 120 as described above.

The one or more processors 311, 321 discussed above may be of any appropriate type that is suitable for the local technical network, and may include one or more of general purpose processors, special purpose processor, microprocessors, a digital signal processor (DSP), one or more processors in a processor based multi-core processor architecture, as well as dedicated processors such as those developed based on Field Programmable Gate Array (FPGA) and Application Specific Integrated Circuit (ASIC). The one or more processors 311, 321 may be configured to control other elements of the UE/network device and operate in cooperation with them to implement the procedures discussed above.

The one or more memories 312, 322 may include at least one storage medium in various forms, such as a volatile memory and/or a non-volatile memory. The volatile memory may include but not limited to for example a random access memory (RAM) or a cache. The non-volatile memory may include but not limited to for example a read only memory (ROM), a hard disk, a flash memory, and the like. Further, the one or more memories 312, 322 may include but not limited to an electric, a magnetic, an optical, an electromagnetic, an infrared, or a semiconductor system, apparatus, or device or any combination of above.

FIG. 4 shows a flow chart illustrating an example method 400 for facilitating the limited logical channel identification (LCID) space according to an embodiment of the present disclosure. The example method 400 may be performed for example at a terminal device such as the UE 110.

Referring to the FIG. 4, the example method 400 may include a step 410 of receiving, from a network device, a mapping configuration of at least one Logical Channel Identification (LCID) value and/or at least one extended LCID (eLCID) value configured by the network device for at least one Media Access Control (MAC) Control Element (CE), wherein the mapping configuration specifies an association between the at least one MAC CE is associated with the at least one Logical Channel Identification (LCID) value and/or the at least one extended LCID (eLCID) value.

Details of the step 410 have been described in above descriptions with respect to at least the operation 220, and repetitive descriptions thereof are omitted here.

In an embodiment, the at least one MAC CE is associated with at least one pointer by which a respective one of the at least one MAC CE is linked to corresponding one or more of the at least one LCID value and/or the at least one eLCID value in radio resource control (RRC) signaling.

In an embodiment, the at least one pointer is an index with a value fixed in a radio standard specification or a value determined by the network device.

In an embodiment, receiving, from a network device, a mapping configuration of at least one Logical Channel Identification (LCID) value and/or the at least one extended LCID (eLCID) value configured by the network device for at least one Media Access Control (MAC) Control Element (CE) comprises: receiving, from the network device, the mapping configuration of the at least one Logical Channel Identification (LCID) value and/or the at least one extended LCID (eLCID) value for the at least one Media Access Control (MAC) Control Element (CE) through RRC signaling.

In an embodiment, receiving, from the network device, a mapping configuration of at least one Logical Channel Identification (LCID) value and/or the at least one extended LCID (eLCID) value configured by the network device for at least one Media Access Control (MAC) Control Element (CE) through RRC signaling comprises: receiving, from the network device, the mapping configuration of a set of LCID values and/or eLCID values for a set of MAC CEs through RRC signaling.

In an embodiment, the at least one MAC CE is associated with at least one LCID value including one or more reserved LCID values or one or more LCID values already allocated in a radio standard specification.

In an embodiment, the one or more LCID values already allocated in a radio standard specification include one or more LCID values for MAC CEs of features that the terminal device is unable to support and/or that the network device does not plan to use for the terminal device.

In an embodiment, the at least one MAC CE is associated with at least one reserved LCID value in the radio standard specification.

In an embodiment, the at least one MAC CE is associated with at least one of a reserved LCID value or an LCID value already allocated to identity of the logical channel in the radio standard specification which has not been assigned to any logical channel for the terminal device.

In an embodiment, the at least one MAC CE is associated with at least one default eLCID value in the radio standard specification and the at least one MAC CE is further associated with at least one available LCID value by the network device in a case where the at least one available LCID value is unused.

In an embodiment, receiving, from a network device, a mapping configuration of at least one Logical Channel Identification (LCID) value and/or the at least one extended LCID (eLCID) value configured by the network device for at least one Media Access Control (MAC) Control Element (CE) comprises: receiving, from the network device, at least one priority to be used in logical channel prioritization for the at least one MAC CE.

In an embodiment, at least two MAC CEs are associated with a common LCID value, each of the at least two MAC CEs is also associated with a unique eLCID value respectively, and the common LCID value is used in a case where the at least two MAC CEs are sent in the same transport block (TB).

In an embodiment, the common LCID value is used for the MAC CE with the highest priority if configured.

In an embodiment, a fixed sequence of MAC CEs is associated with a LCID value and/or an eLCID value by the network device.

In an embodiment, tables of mapping of the at least one MAC CE to the at least one LCID value and/or the at least one eLCID value are specified in the radio standard specification, and the table to be used to associate the at least one MAC CE with the at least one LCID value and/or the at least one eLCID value is determined by the network device.

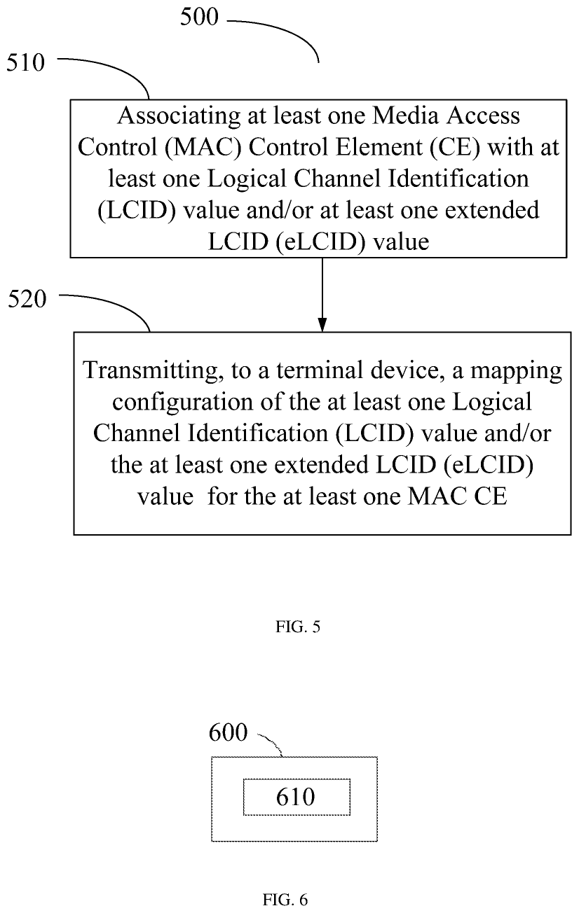

FIG. 5 shows a flow chart illustrating an example method 500 for facilitating the limited logical channel identification (LCID) space according to an embodiment of the present disclosure. The example method 500 may be performed for example at a network device such as the network device 120.

Referring to the FIG. 5, the example method 500 may include a step 510 of associating at least one Media Access Control (MAC) Control Element (CE) with at least one Logical Channel Identification (LCID) value and/or at least one extended LCID (eLCID) value; and a step 520 of transmitting, to a terminal device, a mapping configuration of the at least one Logical Channel Identification (LCID) value and/or the at least one extended LCID (eLCID) value for the at least one MAC CE, wherein the mapping configuration specifies an association between the at least one MAC CE and the at least one Logical Channel Identification (LCID) value and/or the at least one extended LCID (eLCID) value.

Details of the step 510 have been described in above descriptions with respect to at least the operation 210, and descriptions thereof are omitted here.

Details of the step 520 have been described in above descriptions with respect to at least the operation 220, and descriptions thereof are omitted here.

In an embodiment, associating at least one MAC CE with at least one LCID value and/or at least one eLCID value comprises: associating the at least one MAC CE with at least one pointer by which a respective one of the at least one MAC CE is linked to corresponding one or more of the at least one LCID value and/or the at least one eLCID value in radio resource control (RRC) signaling.

In an embodiment, the at least one pointer is an index with a value fixed in a radio standard specification or a value determined by the network device.

In an embodiment, transmitting, to a terminal device, a mapping configuration of the at least one Logical Channel Identification (LCID) value and/or the at least one extended LCID (eLCID) value configured by the network device for the at least one MAC CE comprises: transmitting, to the terminal device, the mapping configuration of the at least one Logical Channel Identification (LCID) value and/or the at least one extended LCID (eLCID) value for the at least one MAC CE through RRC signaling.

In an embodiment, transmitting, to the terminal device, a mapping configuration of the at least one Logical Channel Identification (LCID) value and/or the at least one extended LCID (eLCID) value configured by the network device for the at least one MAC CE through RRC signaling comprises: transmitting, to the terminal device, the mapping configuration of a set of LCID values and/or eLCID values for a set of MAC CEs through RRC signaling.

In an embodiment, associating at least one MAC CE with at least one LCID value and/or at least one eLCID value comprises: associating the at least one MAC CE with at least one LCID value including one or more reserved LCID values or one or more LCID values already allocated in a radio standard specification.

In an embodiment, the one or more LCID values already allocated in a radio standard specification include one or more LCID values for MAC CEs of features that the terminal device is unable to support and/or that the network device does not plan to use for the terminal device.

In an embodiment, associating at least one MAC CE with at least one LCID value and/or at least one eLCID value comprises: associating the at least one MAC CE with at least one reserved LCID value in the radio standard specification.

In an embodiment, associating at least one MAC CE with at least one LCID value and/or at least one eLCID value comprises: associating the at least one MAC CE with at least one of a reserved LCID value or an LCID value already allocated to identity of the logical channel in the radio standard specification which has not been assigned to any logical channel for the terminal device.

In an embodiment, the at least one MAC CE is associated with at least one default eLCID value in the radio standard specification, and associating at least one MAC CE with at least one LCID value and/or at least one eLCID value comprises: associating the at least one MAC CE with at least one available LCID value in a case where the at least one available LCID value is unused.

In an embodiment, transmitting, to a terminal device, a mapping configuration of the at least one Logical Channel Identification (LCID) value and/or the at least one extended LCID (eLCID) value configured by the network device for the at least one MAC CE comprises: transmitting, to the terminal device, at least one priority to be used in logical channel prioritization for the at least one MAC CE.

In an embodiment, associating at least one MAC CE with at least one LCID value and/or at least one eLCID value comprises: associating at least two MAC CEs with a common LCID value; and associating each of the at least two MAC CEs with a unique eLCID value respectively, wherein the common LCID value is used in a case where the at least two MAC CEs are transmitted in the same transport block (TB).

In an embodiment, the common LCID value is used for the MAC CE with the highest priority if configured.

In an embodiment, associating at least one MAC CE with at least one LCID value and/or at least one eLCID value comprises: associating a fixed sequence of MAC CEs with a LCID value and/or an eLCID value.

In an embodiment, tables of mapping of the at least one MAC CE to the at least one LCID value and/or the at least one eLCID value are specified in the radio standard specification, and associating at least one MAC CE with at least one LCID value and/or at least one eLCID value comprises: determining the table to be used to associate the at least one MAC CE with the at least one LCID value and/or the at least one eLCID value.

FIG. 6 shows a block diagram illustrating an example apparatus 600 for facilitating the limited logical channel identification (LCID) space according to an embodiment of the present disclosure. Apparatus, for example, may be at least part of the UE 110 in above examples.

As shown in FIG. 6, the example apparatus 600 may include means 610 for receiving, from a network device, a mapping configuration of at least one Logical Channel Identification (LCID) value and/or at least one extended LCID (eLCID) value configured by the network device for at least one Media Access Control (MAC) Control Element (CE), wherein the mapping configuration specifies an association between the at least one MAC CE is associated with the at least one Logical Channel Identification (LCID) value and/or the at least one extended LCID (eLCID) value. In one or more another example embodiment, at least one I/O interface, at least one antenna element, and the like may also be included in the example apparatus 600.

In some example embodiments, examples of means in the example apparatus 600 may include circuitries. For example, an example of means 610 may include a circuitry configured to perform the step 410 of the example method 400. In some example embodiments, examples of means may also include software modules and any other suitable function entities.

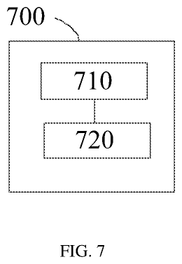

FIG. 7 shows a block diagram illustrating an example apparatus 700 for facilitating the limited logical channel identification (LCID) space according to an embodiment of the present disclosure. Apparatus, for example, may be at least part of the network device 120 in above examples.

As shown in the FIG. 7, the example apparatus 700 may include means 710 for performing the step 510 of the example method 500; and means 720 for performing the step 520 of the example method 500.

In some example embodiments, examples of means in the example apparatus 700 may include circuitries. For example, an example of means 710 may include a circuitry configured to perform the step 510 of the example method 500 and an example of means 720 may include a circuitry configured to perform the step 520 of the example method 500. In some example embodiments, examples of means may also include software modules and any other suitable function entities.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and actions of some embodiments described above can be combined to provide further embodiments. Accompanying claims and their equivalents are intended to cover such forms or modifications as would fall within the scope and spirit of the disclosure.

Abbreviations used in the description and/or in the figures are defined as follows:

| | |
|---|---|
| 3GPP | third generation partnership project |
| 5G | fifth generation |
| BS | base station |
| BSR | buffer status report |
| CE | control element |
| DL-SCH | downlink-shared channel |
| DRB | data radio bearer |
| eLCID | extended LCID |
| gNB | next generation NodeB/5G base station |
| LBT | listen before talk |
| LCH | logical channel |
| LCID | logical channel identification |
| MAC | medium access control |
| NW | network |
| PDU | protocol data unit |
| PHR | power headroom report |
| RA | random access |
| RRC | radio resource control |
| TB | transport block |
| TS | technical specification |
| UE | user equipment |
| UL-SCH | uplink-shared channel |

1. A terminal device comprising:
at least one processor; and
at least one memory comprising computer program code, the at least one memory and the computer program code being configured to, with the at least one processor, cause the terminal device to perform:
receiving, from a network device, a mapping configuration of at least one Logical Channel Identification (LCID) value and/or at least one extended LCID (eLCID) value configured by the network device for at least one Media Access Control (MAC) Control Element (CE),
wherein the mapping configuration specifies an association between the at least one MAC CE and the at least one Logical Channel Identification (LCID) value and/or the at least one extended LCID (eLCID) value.

2. The terminal device of claim 1, wherein the at least one MAC CE is associated with at least one pointer by which a respective one of the at least one MAC CE is linked to corresponding one or more of the at least one LCID value and/or the at least one eLCID value in radio resource control (RRC) signaling for the terminal device.

3. The terminal device of claim 2, wherein the at least one pointer is an index with a value fixed in a radio standard specification or a value determined by the network device.

4. The terminal device of claim 1, wherein receiving, from a network device, a mapping configuration of at least one Logical Channel Identification (LCID) value and/or the at least one extended LCID (eLCID) value configured by the network device for at least one Media Access Control (MAC) Control Element (CE) comprises:
receiving, from the network device, the mapping configuration of the at least one Logical Channel Identification (LCID) value and/or the at least one extended LCID (eLCID) value for the at least one Media Access Control (MAC) Control Element (CE) through RRC signaling.

5. The terminal device of claim 4, wherein receiving, from the network device, a mapping configuration of at least one Logical Channel Identification (LCID) value and/or the at least one extended LCID (eLCID) value configured by the network device for at least one Media Access Control (MAC) Control Element (CE) through RRC signaling comprises:
receiving, from the network device, the mapping configuration of a set of LCID values and/or eLCID values for a set of MAC CEs through RRC signaling.

6. The terminal device of claim 1, wherein the at least one MAC CE is associated with at least one LCID value including one or more reserved LCID values or one or more LCID values already allocated in a radio standard specification.

7. The terminal device of claim 6, wherein the one or more LCID values already allocated in a radio standard specification include one or more LCID values for MAC CEs of features that the terminal device is unable to support and/or that the network device does not plan to use for the terminal device.

8. The terminal device of claim 1, wherein the at least one MAC CE is associated with at least one reserved LCID values in the radio standard specification.

9. The terminal device of claim 1, wherein the at least one MAC CE is associated with at least one of a reserved LCID value or an LCID value already allocated to identity of the logical channel in the radio standard specification which has not been assigned to any logical channel for the terminal device.

10. The terminal device of claim 1, wherein the at least one MAC CE is associated with at least one default eLCID value in the radio standard specification and the at least one MAC CE is further associated with at least one available LCID value by the network device in a case where the at least one available LCID value is unused.

11. The terminal device of claim 1, wherein the at least one MAC CE is associated with at least one default LCID value in the radio standard specification and the at least one MAC CE is further associated with at least one available eLCID value by the network device in a case where the at least one available eLCID value is unused.

12. The terminal device of claim 1, wherein receiving, from a network device, a mapping configuration of at least one Logical Channel Identification (LCID) value and/or the at least one extended LCID (eLCID) value configured by the network device for at least one Media Access Control (MAC) Control Element (CE) comprises:
receiving, from the network device, at least one priority to be used in logical channel prioritization for the at least one MAC CE.

13. The terminal device of claim 1, wherein at least two MAC CEs are associated with a common LCID value, each of the at least two MAC CEs is also associated with a unique eLCID value respectively, and the common LCID value is used in a case where the at least two MAC CEs are transmitted in the same transport block (TB).

14. The terminal device of claim 13, wherein the common LCID value is used for the MAC CE with the highest priority if configured.

15. The terminal device of claim 1, wherein a fixed sequence of MAC CEs is associated with a LCID value and/or an eLCID value by the network device.

16. The terminal device of claim 1, wherein tables of mapping of the at least one MAC CE to the at least one LCID value and/or the at least one eLCID value are specified in the radio standard specification, and the table to be used to associate the at least one MAC CE with the at least one LCID value and/or the at least one eLCID value is determined by the network device.

17-32. (canceled)

33. A method implemented at a terminal device comprising:
receiving, from a network device, a mapping configuration of at least one Logical Channel Identification (LCID) value and/or at least one extended LCID (eLCID) value configured by the network device for at least one Media Access Control (MAC) Control Element (CE),
wherein the mapping configuration specifies an association between the at least one MAC CE is associated with the at least one Logical Channel Identification (LCID) value and/or the at least one extended LCID (eLCID) value.

34-35. (canceled)

36. The method of claim 33, wherein receiving, from a network device, a mapping configuration of at least one Logical Channel Identification (LCID) value and/or the at least one extended LCID (eLCID) value configured by the network device for at least one Media Access Control (MAC) Control Element (CE) comprises:
receiving, from the network device, the mapping configuration of the at least one Logical Channel Identification (LCID) value and/or the at least one extended LCID (eLCID) value for the at least one Media Access Control (MAC) Control Element (CE) through RRC signaling.

37. The method of claim 36, wherein receiving, from the network device, a mapping configuration of at least one Logical Channel Identification (LCID) value and/or the at least one extended LCID (eLCID) value configured by the network device for at least one Media Access Control (MAC) Control Element (CE) through RRC signaling comprises:
receiving, from the network device, the mapping configuration of a set of LCID values and/or eLCID values for a set of MAC CEs through RRC signaling.

38-43. (canceled)

44. The method of claim 33, wherein receiving, from a network device, a mapping configuration of at least one Logical Channel Identification (LCID) value and/or the at least one extended LCID (eLCID) value configured by the network device for at least one Media Access Control (MAC) Control Element (CE) comprises:
receiving, from the network device, at least one priority to be used in logical channel prioritization for the at least one MAC CE.

45-68. (canceled)
